(19) United States
(12) Patent Application Publication
(10) Pub. No.: US 2012/0102930 A1
(43) Pub. Date: May 3, 2012

(54) SYSTEM FOR DESULFURIZING OXIDATION CATALYST AND METHOD THEREOF

(75) Inventor: Jun Sung Park, Yongin-city (KR)

(73) Assignee: Hyundai Motor Company, Seoul (KR)

(21) Appl. No.: 13/182,217

(22) Filed: Jul. 13, 2011

(30) Foreign Application Priority Data
Nov. 3, 2010 (KR) 10-2010-0108881

(51) Int. Cl. F01N 3/10; B01J 38/02

(52) U.S. Cl. 60/299; 502/6

(57) ABSTRACT

A system and method for desulfurizing an oxidation catalyst enhances fuel economy and reduces noxious exhaust gas emission as a consequence of increasing desulfurization period of the oxidation catalyst or shortening desulfurization time by reflecting desulfurization history consisting of natural desulfurization occurrence. The method may include detecting an inlet temperature of the oxidation catalyst, estimating natural desulfurization according to the inlet temperature of the oxidation catalyst, and resetting desulfurization time or desulfurization period by reflecting the estimated natural desulfurization.

### CROSS-REFERENCE TO RELATED APPLICATION

This application claims priority to and the benefit of Korean Patent Application No. 10-2010-0108881 filed on Nov. 3, 2010, the entire contents of which application is incorporated herein for all purposes by this reference.

### BACKGROUND OF INVENTION

1. Field of Invention

The present invention relates to a system for desulfurizing an oxidation catalyst and a method thereof. More particularly, the present invention relates to a system for desulfurizing an oxidation catalyst and a method thereof which reduce fuel consumption and purify noxious exhaust gas as a consequence of increasing desulfurization period of the oxidation catalyst or shortening desulfurization time by reflecting desulfurization history considering natural desulfurization occurrence.

2. Description of Related Art

An exhaust gas generated from an internal combustion engine contains harmful substances such as carbon monoxide (CO), hydrocarbon (HC), and soluble organic fraction (SOF), and an oxidation catalyst is generally used for cleaning these harmful substances.

The oxidation catalyst purifies CO and HC into CO₂ and H₂O by using a catalyst of platinum family coated on a ceramic carrier.

The oxidation catalyst has two degradation mechanisms. One of them is non-reversible degradation wherein the catalyst is exposed to high temperature and effective surface area is reduced, and the other of them is reversible sulfur-poisoning wherein reaction sites are contaminated and reduced by sulfur.

The reversible sulfur-poisoning means that activity of the oxidation catalyst is deteriorated by the sulfur contained in fuel or engine oil. Since the sulfur-poisoning is reversible reaction, the deteriorated activity of the oxidation catalyst can be restored.

It is called “desulfurization” that the activity of the oxidation catalyst is restored from the sulfur-poisoning. The desulfurization is generally performed by exposing the oxidation catalyst to high temperature (e.g., higher than 450° C.).

That is, the desulfurization of the oxidation catalyst is performed by exposing the oxidation catalyst to the high temperature (e.g., higher than 450° C.) when desulfurization period according to travel distance or driving time is reached, or oxidizing performance of the oxidation catalyst falls below a predetermined level.

However, in order to make the oxidation catalyst exposed to high temperature environment in desulfurization, fuel must be post-injected or be additionally injected. Therefore, additional fuel may be used and fuel economy may be worsen.

As shown in FIG. 9, the desulfurization of the oxidation catalyst is repetitively performed by means of post-injection at every predetermined travel distance (e.g., 15,000 km) for every predetermined time (e.g., 5 min.).

If the desulfurization of the oxidation catalyst is performed at every predetermined desulfurization period, the activity of the oxidation catalyst can be restored but additional fuel consumption is necessary to make the high temperature environment. Thereby fuel economy may be deteriorated, noxious exhaust gas may increase, and oil dilution may occur.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a system for desulfurizing an oxidation catalyst and a method thereof having advantages of enhancing fuel consumption, reducing noxious exhaust gas, and minimizing non-reversible degradation of the oxidation catalyst as a consequence of increasing desulfurization period of the oxidation catalyst or shortening desulfurization time by reflecting desulfurization history considering natural desulfurization occurrence.

A system for desulfurizing an oxidation catalyst according to various aspects of the present invention may include an engine, an oxidation catalyst purifying harmful substances contained in exhaust gas, a temperature detector detecting inlet temperature of the oxidation catalyst, and a control portion integrating a time or a distance where natural desulfurization occurs based on the inlet temperature of the oxidation catalyst, and performing desulfurization of the oxidation catalyst by reflecting integrated natural desulfurization occurrence time or integrated natural desulfurization occurrence distance on a predetermined desulfurization time or a predetermined desulfurization period.

The control portion may calculate integrated time or integrated distance where the inlet temperature of the oxidation catalyst is higher than a predetermined desulfurization temperature as the natural desulfurization occurrence time or the natural desulfurization occurrence distance.

The control portion may be adapted to reduce desulfurization time by subtracting a value corresponding to the integrated natural desulfurization occurrence time from the predetermined desulfurization time.

The control portion may be adapted to increase desulfurization period by reflecting a value corresponding to the integrated natural desulfurization occurrence time on the predetermined desulfurization period.

The control portion may maintain the predetermined desulfurization period in a case of reducing the desulfurization time.

The control portion may maintain the predetermined desulfurization time in a case of increasing the desulfurization period.

The control portion may reflect the integrated natural desulfurization occurrence time of the oxidation catalyst simultaneously on the desulfurization time and the desulfurization period.

A system for desulfurizing an oxidation catalyst according to other aspects of the present invention may include an oxidation catalyst purifying harmful substances contained in exhaust gas, a temperature detector detecting inlet temperature of the oxidation catalyst, and a control portion calculating desulfurization efficiency according to the inlet temperature of the oxidation catalyst, estimating natural desulfurization degree of the oxidation catalyst by integrating the desulfurization efficiency according to the inlet temperature of the oxidation catalyst to time or distance, and performing desulfurization of the oxidation catalyst by reflecting the estimated natural desulfurization degree on a predetermined desulfurization time or a predetermined desulfurization period.

The control portion may be adapted to reduce desulfurization time by subtracting a value corresponding to the estimated natural desulfurization degree from the predetermined desulfurization time.

The control portion may be adapted to increase desulfurization period by adding a value corresponding to the estimated natural desulfurization degree to the predetermined desulfurization period.

The control portion may maintain the predetermined desulfurization period in a case of reducing the desulfurization time.

The control portion may maintain the predetermined desulfurization time in a case of increasing the desulfurization period.

The control portion may reflect the estimated natural desulfurization degree simultaneously on the desulfurization time and the desulfurization period.

A method for desulfurizing an oxidation catalyst according to other aspects of the present invention may include integrating a time during which an inlet temperature of the oxidation catalyst is higher than a predetermined desulfurization temperature, resetting, in a case that a predetermined desulfurization period of the oxidation catalyst is reached, desulfurization time by reflecting an integrated time during which the inlet temperature of the oxidation catalyst is higher than a predetermined desulfurization temperature on a predetermined desulfurization time, and controlling desulfurization of the oxidation catalyst according to the reset desulfurization time.

The predetermined desulfurization period may be maintained when resetting the desulfurization time.

A method for desulfurizing an oxidation catalyst according to other aspects of the present invention may include integrating a time during which an inlet temperature of the oxidation catalyst is higher than a predetermined desulfurization temperature, resetting, in a case that a predetermined desulfurization period of the oxidation catalyst is reached, desulfurization period by reflecting an integrated time during which the inlet temperature of the oxidation catalyst is higher than a predetermined desulfurization temperature on a predetermined desulfurization period, and controlling desulfurization of the oxidation catalyst according to the reset predetermined desulfurization period.

The predetermined desulfurization time may be maintained when resetting the desulfurization period.

A method for desulfurizing an oxidation catalyst according to other aspects of the present invention may include detecting an inlet temperature of the oxidation catalyst, calculating desulfurization efficiency according to the inlet temperature of the oxidation catalyst, estimating natural desulfurization degree by integrating the desulfurization efficiency according to the inlet temperature of the oxidation catalyst to time or distance, resetting, in a case that a predetermined desulfurization period of the oxidation catalyst is reached, desulfurization time by reflecting the estimated natural desulfurization degree on a predetermined desulfurization time, and controlling desulfurization of the oxidation catalyst according to the reset desulfurization time.

A method for desulfurizing an oxidation catalyst according to other aspects of the present invention may include detecting an inlet temperature of the oxidation catalyst, calculating desulfurization efficiency according to the inlet temperature of the oxidation catalyst, estimating natural desulfurization degree by integrating the desulfurization efficiency according to the inlet temperature of the oxidation catalyst to time or distance, resetting, in a case that a predetermined desulfurization period of the oxidation catalyst is reached, desulfurization period by reflecting the estimated natural desulfurization degree on a predetermined desulfurization period, and controlling desulfurization of the oxidation catalyst according to the reset desulfurization period.

A method for desulfurizing an oxidation catalyst according to other aspects of the present invention may include detecting an inlet temperature of the oxidation catalyst, estimating natural desulfurization according to the inlet temperature of the oxidation catalyst, and resetting desulfurization time or desulfurization period by reflecting the estimated natural desulfurization.

The natural desulfurization of the oxidation catalyst may be estimated by integrating a time during which the inlet temperature of the oxidation catalyst is higher than a predetermined desulfurization temperature.

The natural desulfurization of the oxidation catalyst may be estimated by integrating desulfurization efficiency according to the inlet temperature of the oxidation catalyst to time.

The predetermined desulfurization period may be maintained and the natural desulfurization may be reflected on the desulfurization time in a case that the predetermined desulfurization period of the oxidation catalyst is reached.

The predetermined desulfurization time may be maintained and the natural desulfurization may be reflected on the desulfurization period in a case that the predetermined desulfurization period of the oxidation catalyst is reached.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary system for desulfurizing an oxidation catalyst according to the present invention.

FIG. 2 is a flowchart of an exemplary method for desulfurizing an oxidation catalyst according to the present invention.

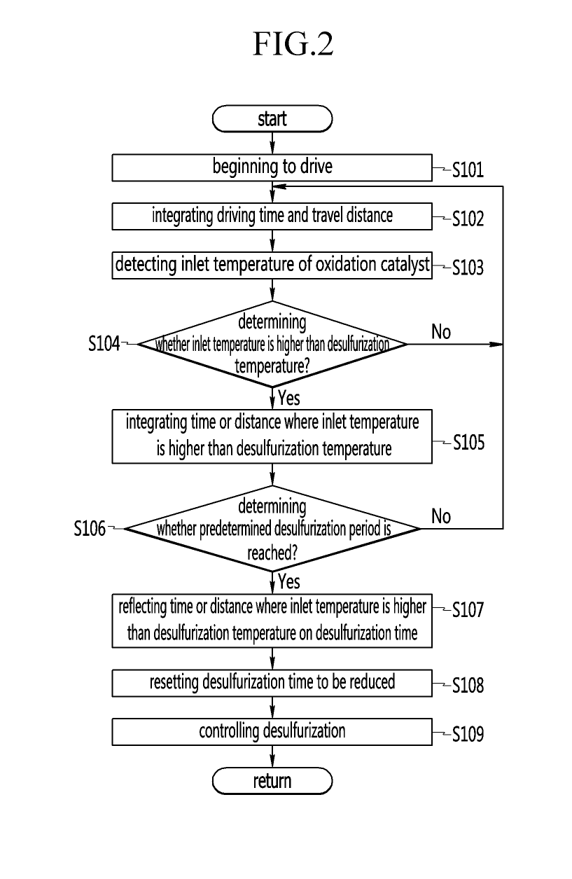

FIG. 3 is an exemplary schematic diagram for explaining desulfurization of an oxidation catalyst according to the present invention.

FIG. 4 is a flowchart of an exemplary method for desulfurizing an oxidation catalyst according to the present invention.

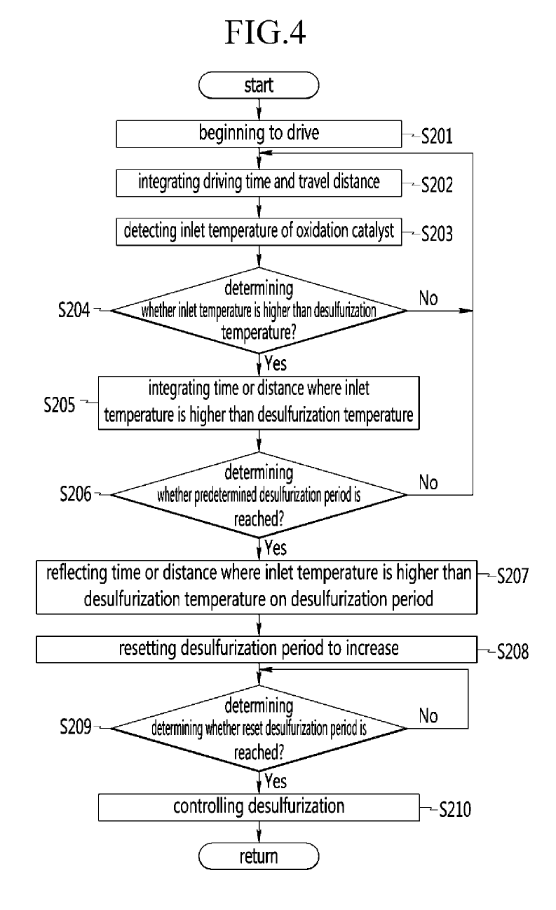

FIG. 5 is an exemplary schematic diagram for explaining desulfurization of an oxidation catalyst according to the present invention.

FIG. 6 is a flowchart of an exemplary method for desulfurizing an oxidation catalyst according to the present invention.

FIG. 7 is an exemplary graph illustrating desulfurization efficiency according to a temperature of an oxidation catalyst applied in accordance with the present invention.

FIG. 8 is a flowchart of an exemplary method for desulfurizing an oxidation catalyst according to the present invention.

FIG. 9 illustrates desulfurization period of the oxidation catalyst applied to a conventional vehicle.

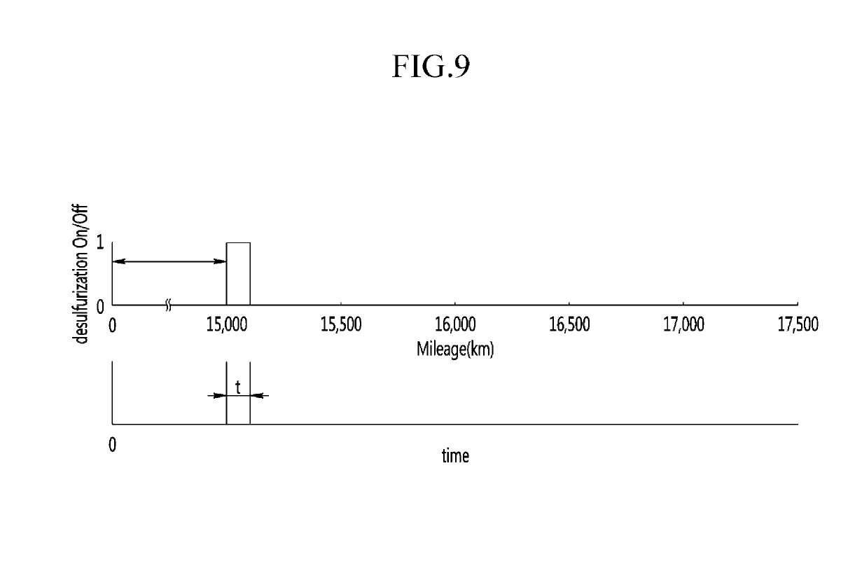

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Description of components that are not necessary for explaining the present invention will be omitted, and the same constituent elements are denoted by the same reference numerals in this specification.

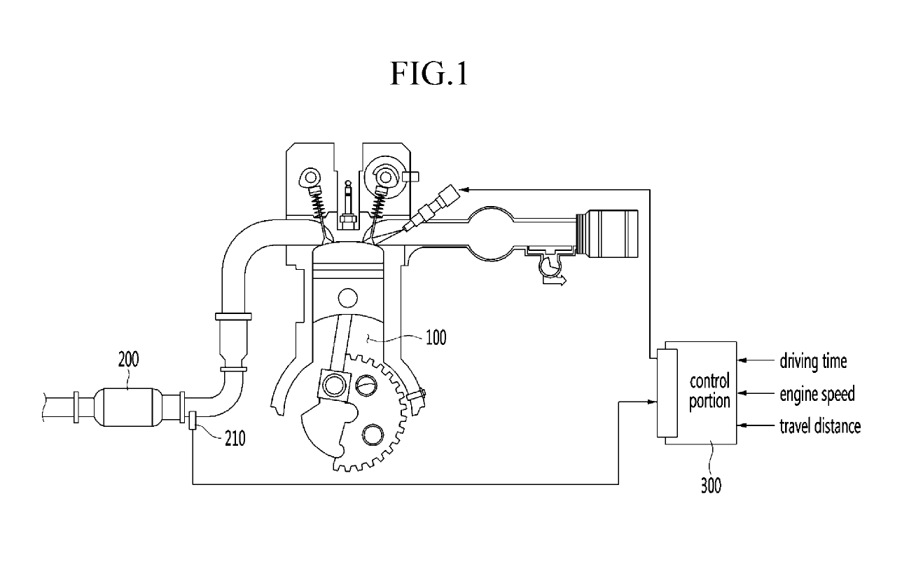

Referring to FIG. 1, a system for desulfurizing an oxidation catalyst according to various embodiments of the present invention includes an engine 100, an oxidation catalyst 200, a temperature detector 210, and a control unit or control portion 300.

The engine 100 burns air-fuel mixture in which air and fuel are mixed according to driving demand and load condition so as to generate power, and exhausts exhaust gas generated from combustion process to the atmosphere through an exhaust pipe.

The oxidation catalyst 200 purifies harmful substances such as CO, HC, and SOF contained in the exhaust gas passing through the exhaust pipe into CO₂ and H₂O by using a catalyst of platinum family coated on a ceramic carrier.

The temperature detector 210 is disposed at an upstream of the oxidation catalyst 200, detects temperature of the exhaust gas flowing into the oxidation catalyst 200, and transmits inlet temperature of the oxidation catalyst 200 to the control portion 300.

The control portion 300 analyzes information transmitted from the temperature detector 210 at a normal driving mode (e.g., a driving mode at which forcible desulfurization does not occur) and integrates a time or a distance where the inlet temperature of the oxidation catalyst 200 is higher than a predetermined desulfurization temperature (e.g., 450° C.).

That is, the control portion 300 integrates the time or the distance where the natural desulfurization occurs at the normal driving mode.

If a predetermined desulfurization period (e.g., 15,000 km) is reached, the control portion 300 subtracts a value corresponding to the integrated time or integrated distance where the natural desulfurization occurs from the predetermined desulfurization time (e.g., 5 min.) or the predetermined desulfurization distance. That is, the control portion 300 resets desulfurization time of the oxidation catalyst 200 by reducing the same corresponding to the integrated time or the integrated distance where the natural desulfurization occurs, and controls the desulfurization of the oxidation catalyst 200 according to the reset desulfurization time.

For example, the desulfurization time which was set to about 5 min. at the normal driving mode is shortened to 3 min. or 4 min. by reflecting the time or the distance where the inlet temperature of the oxidation catalyst is higher than the desulfurization temperature at the normal driving mode. Accordingly, post-injecting time for desulfurization may be shortened and fuel economy may be improved.

In addition, the control portion 300 analyzes the information transmitted from the temperature detector 210 at the normal driving mode and integrates the time or the distance where the inlet temperature of the oxidation catalyst 200 is higher than the predetermined desulfurization temperature (e.g., 450° C.).

If the predetermined desulfurization period (e.g., 15,000 km) is reached, the control portion 300 increases desulfurization period of the oxidation catalyst 200 corresponding to the time or the distance where the inlet temperature of the oxidation catalyst 200 is higher than the predetermined desulfurization temperature (e.g., 450° C.), and controls the desulfurization of the oxidation catalyst 200 according to the reset desulfurization period.

For example, the desulfurization period which was set to about 15,000 km at the normal driving mode may be increased to 17,000 km. Therefore, the desulfurization may be performed at every 17,000 km.

The reset desulfurization period is variably updated according to the integrated time or the integrated distance where the oxidation catalyst 200 is exposed to the desulfurization temperature.

The control portion 300 may calculate desulfurization efficiency according to the inlet temperature of the oxidation catalyst 200 based on the inlet temperature of the oxidation catalyst 200 detected by the temperature detector 210 at the normal driving mode, and may calculate natural desulfurization degree by integrating the desulfurization efficiency according to the inlet temperature of the oxidation catalyst 20 to time or distance. Therefore, the control portion 300 can estimate actual sulfur-poisoning of the oxidation catalyst 200.

If the predetermined desulfurization period (e.g., 15,000 km) is reached, the control portion 300 resets the predetermined desulfurization time (e.g., 5 min.) by reducing it according to the actual sulfur-poisoning of the oxidation catalyst 200, and controls the desulfurization of the oxidation catalyst 200 according to the reset desulfurization time.

Therefore, post-injecting time for increasing exhaust gas temperature can be shortened, and accordingly, fuel economy may be enhanced and noxious exhaust gas emission may be reduced.

In addition, the control portion 300 may calculate the desulfurization efficiency according to the inlet temperature of the oxidation catalyst 200 based on the inlet temperature of the oxidation catalyst 200 detected by the temperature detector 210 at the normal driving mode, and may calculate the natural desulfurization degree by integrating the desulfurization efficiency according to the inlet temperature of the oxidation catalyst 20 to time or distance. Therefore, the control portion 300 can estimate actual sulfur-poisoning of the oxidation catalyst 200.

If the predetermined desulfurization period (e.g., 15,000 km) is reached, the control portion 300 resets the predetermined desulfurization period by increasing it (e.g., to be 17,000 km) according to the actual sulfur-poisoning of the oxidation catalyst 200, and controls the desulfurization of the oxidation catalyst 200 according to the reset desulfurization period.

Therefore, since post-injection for increasing exhaust gas temperature may not be performed frequently due to extension of the desulfurization period, fuel economy may be enhanced and noxious exhaust gas emission may be reduced.

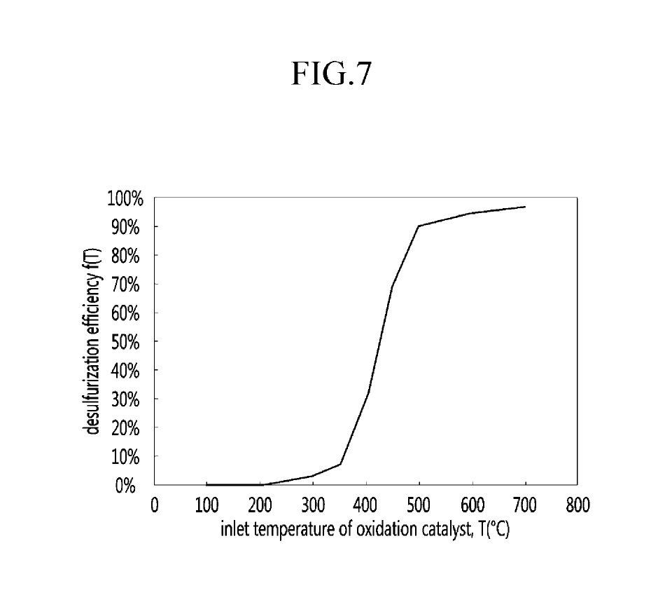

The control portion 300 calculates the desulfurization efficiency according to the inlet temperature of the oxidation catalyst 200 based on the graph illustrated in FIG. 7.

In addition, the control portion 300 can estimate the inlet temperature of the oxidation catalyst 200 from a driving condition of the engine 100.

A method for desulfurizing an oxidation catalyst according to various embodiments of the present invention will be described in detail.

If the engine 100 begins to operate at a step S101 the control portion 300 integrates driving time by using a counter and travel distance (mileage) by using an integrating meter at a step S102.

The control portion 300 can receive information about the driving time and the travel distance from a trip computer.

In addition, the control portion 300 detects temperature of the exhaust gas passing through the inlet of the oxidation catalyst 200 by using the temperature detector 210 at a step S103, and determines whether the inlet temperature of the oxidation catalyst 200 is higher than the predetermined desulfurization temperature (e.g., 450° C.) at a step S104. That is, the control portion 300 determines whether the natural desulfurization occurs.

If the inlet temperature of the oxidation catalyst 200 is not higher than the predetermined desulfurization temperature (e.g., 450° C.) at the step S104, the control portion 300 returns to the step S102.

If the inlet temperature of the oxidation catalyst 200, however, is higher than the predetermined desulfurization temperature (e.g., 450° C.) by effects of various driving environments at the step S104, the control portion 300 integrates a time or a distance where the inlet temperature of the oxidation catalyst 200 is higher than the predetermined desulfurization temperature (e.g., 450° C.) at a step S105.

That is, a time or a distance where the natural desulfurization occurs is integrated.

After that, the control portion 300 analyzes information transmitted from the integrating meter, the trip computer or the counter and determines whether the predetermined desulfurization period (e.g., 15,000 km) is reached at a step S106.

If the predetermined desulfurization period (e.g., 15,000 km) is not reached at the step S106, the control portion 300 returns to the step S102. If the predetermined desulfurization period (e.g., 15,000 km), on the contrary, is reached at the step S106, the control portion reflects a value corresponding to the integrated time or the integrated distance where the inlet temperature of the oxidation catalyst 200 is higher than the desulfurization temperature (e.g., 450° C.) on a predetermined desulfurization time (e.g., 5 min.) at a step S107, and resets desulfurization time at a step S108.

That is, the control portion 300 determines that the natural desulfurization of the oxidation catalyst 200 occurs during the integrated time or the integrated distance where the inlet temperature of the oxidation catalyst 200 is higher than the desulfurization temperature (e.g., 450° C.) at the normal driving mode, and shortens the desulfurization time by subtracting the value corresponding to the time or the distance where the natural desulfurization occurs from the predetermined desulfurization time (e.g., 5 min.).

t_{new}(reset desulfurization time)=t(predetermined desulfurization time)−Δt(value corresponding to time where natural desulfurization occurs)

If the desulfurization time is reset, the control portion 300 controls the post-injection according to the reset desulfurization time so as to increase the temperature of the exhaust gas. Since the inlet temperature of the oxidation catalyst 200 becomes higher than the desulfurization temperature (e.g., 450° C.), the sulfur poisoned at the oxidation catalyst 200 is removed and the oxidation catalyst 200 is regenerated at a step S109. In this patent, the regeneration of the oxidation catalyst 200 means that the sulfur poisoned at the oxidation catalyst 200 is removed by the hot exhaust gas.

After that, if the desulfurization of the oxidation catalyst 200 is performed for the reset desulfurization time, the control portion 300 determines that the regeneration of the oxidation catalyst 200 is completed and returns to the initial step.

Therefore, since the desulfurization time for removing the sulfur poisoned at the oxidation catalyst 200 is minimized, fuel economy may be enhanced and noxious exhaust gas may be reduced.

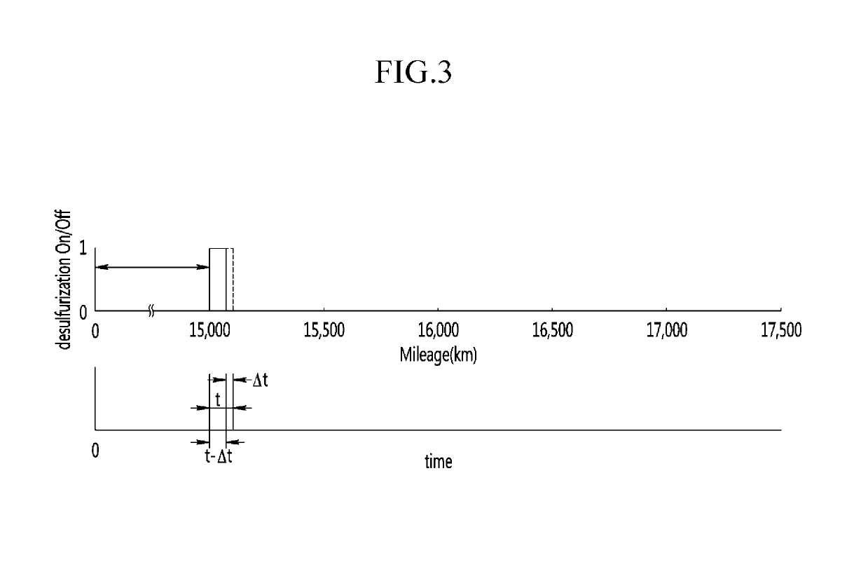

As shown in FIG. 3, the desulfurization of a conventional vehicle is performed for the predetermined desulfurization time t (e.g., 5 min.) at every predetermined desulfurization period (e.g., 15,000 km). However, if the predetermined desulfurization period (e.g., 15,000 km) is reached according to various embodiments of the present invention, it is determined that the natural desulfurization of the oxidation catalyst 200 occurs for the integrated time At where the inlet temperature of the oxidation catalyst 200 is higher than the desulfurization temperature (e.g., 450° C.).

Therefore, the desulfurization time is reset to the reduced desulfurization time t−Δt by subtracting the integrated time Δt where the natural desulfurization occurs from the predetermined desulfurization time t, and the desulfurization is performed.

If the engine 100 begins to operate at a step S201, the control portion 300 integrates the driving time and the travel distance at a step S202.

The control portion 300 detects the temperature of the exhaust gas passing through the inlet of the oxidation catalyst 200 by using the temperature detector 210 at a step S203, and determines whether the inlet temperature of the oxidation catalyst 200 is higher than the predetermined desulfurization temperature (e.g., 450° C.) at a step S204.

If the inlet temperature of the oxidation catalyst 200 is not higher than the predetermined desulfurization temperature (e.g., 450° C.) at the step S204, the control portion 300 returns to the step S202.

If the inlet temperature of the oxidation catalyst 200, however, is higher than the predetermined desulfurization temperature (e.g., 450° C.) at the step S204, the control portion 300 integrates the time or the distance where the inlet temperature of the oxidation catalyst 200 is higher than the predetermined desulfurization temperature (e.g., 450° C.) at a step S205.

After that, the control portion 300 determines whether the predetermined desulfurization period (e.g., 15,000 km) is reached at a step S206.

If the predetermined desulfurization period (e.g., 15,000 km) is not reached at the step S206, the control portion 300 returns to the step S202.

If the predetermined desulfurization period (e.g., 15,000 km), however, is reached at the step S206, the control portion 300 reflects the value corresponding to the integrated time or the integrated distance where the inlet temperature of the oxidation catalyst 200 is higher than the desulfurization temperature (e.g., 450° C.) at the normal driving mode on the predetermined desulfurization period (e.g., 15,000 km) at a step S207, and resets the desulfurization period to increase at a step S208.

That is, the desulfurization period is increased by adding the integrated time or the integrated distance where the natural desulfurization of the oxidation catalyst 200 occurs to the predetermined desulfurization period.

T(reset desulfurization period)=T(predetermined desulfurization period)+T(predetermined desulfurization period)×Δt(value corresponding to time where natural desulfurization occurs normal driving mode)/t(predetermined desulfurization time)

After that, the control portion 300 determines whether the reset desulfurization period is reached at a step S209. If the reset desulfurization period is reached at the step S209, the control portion 300 performs the desulfurization of the oxidation catalyst 200 for the predetermined desulfurization time (e.g., 5 min.) through the post-injection at a step S210.

After that, if the desulfurization of the oxidation catalyst 200 is completed, the control portion 300 determines that the regeneration of the oxidation catalyst 200 is completed and returns to the initial step.

Therefore, since the desulfurization of the oxidation catalyst 200 for removing the poisoned sulfur does not occur frequently, fuel economy may be enhanced and noxious exhaust gas emission may be reduced.

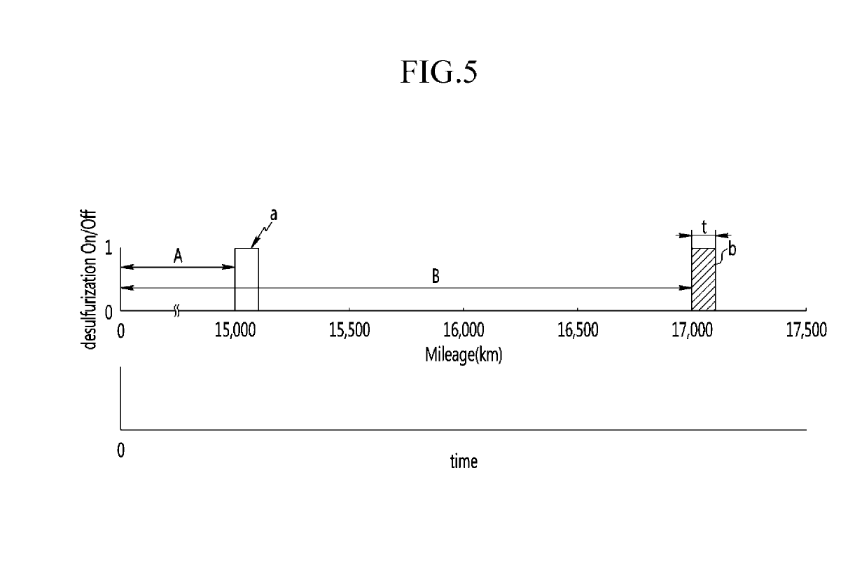

As shown in FIG. 5, the desulfurization of a conventional vehicle is performed for the predetermined desulfurization time t (e.g., 5 min.) at every predetermined desulfurization period (e.g., 15,000 km). However, the desulfurization period B (e.g., 17,000 km) is reset by reflecting the integrated time where the inlet temperature of the oxidation catalyst 200 is higher than the desulfurization temperature (e.g., 450° C.) on the desulfurization period according to various embodiments of the present invention. After that, if the reset desulfurization period B is reached, the desulfurization is performed for the predetermined desulfurization time b. Herein, the predetermined desulfurization times a and b may be the same or be different.

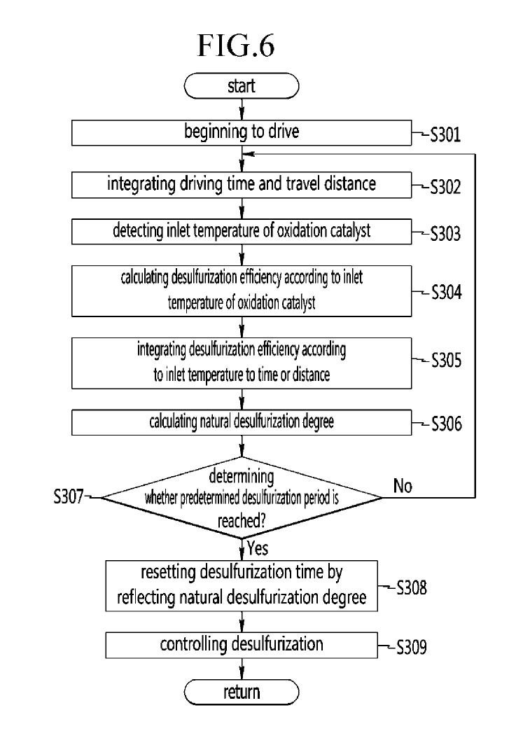

With reference to FIG. 6, if the engine 100 begins to operate at a step S301, the control portion 300 integrates the driving time and the travel distance at a step S302.

In addition, the control portion 300 detects the temperature of the exhaust gas passing through the inlet of the oxidation catalyst 200 by using the temperature detector 210 at a step S303, and calculates the desulfurization efficiency according to the inlet temperature of the oxidation catalyst 200 by using characteristic graph shown in FIG. 7 at a step S304.

After that, the control portion 300 integrates the desulfurization efficiency according to the inlet temperature of the oxidation catalyst 200 to time or distance at a step S305 and calculates natural desulfurization degree occurring at the normal driving mode at a step S306.

The control portion 300 determines whether the predetermined desulfurization period (e.g., 15,000 km) is reached at a step S307.

If the predetermined desulfurization period (e.g., 15,000 km) is not reached at the step S307, the control portion 300 returns to the step S302.

If the predetermined desulfurization period (e.g., 15,000 km), however, is reached at the step S307, the control portion 300 resets the desulfurization time by reflecting the integrated desulfurization efficiency on the predetermined desulfurization time (e.g., 5 min.) at a step S308.

That is, the control portion 300 subtracts a value corresponding to the natural desulfurization degree occurring at the normal driving mode from the predetermined desulfurization time (e.g., 5 min.) and resets the desulfurization time to be shortened.

If the desulfurization time is reset, the control portion 300 raises the temperature of the exhaust gas according to the reset desulfurization time through the post-injection. Since the inlet temperature of the oxidation catalyst 200 becomes higher than the desulfurization temperature (e.g., 450° C.), the sulfur poisoned at the oxidation catalyst 200 is removed and the oxidation catalyst 200 is regenerated at a step S309.

After that, if the desulfurization of the oxidation catalyst 200 is performed for the reset desulfurization time, the control portion 300 determines that the regeneration of the oxidation catalyst 200 is completed and returns to the initial step.

Therefore, since the desulfurization time for regenerating the oxidation catalyst 200 is shortened, fuel economy may be enhanced and noxious exhaust gas emission may be reduced.

Reduction of the desulfurization time according to other exemplary embodiments is similar to that according to that described above, and thus detailed description will be omitted.

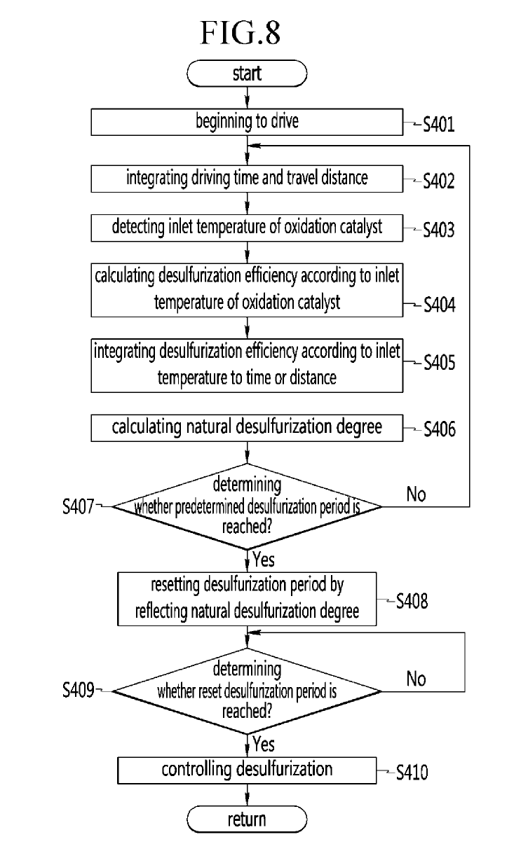

With reference to FIG. 8, if the engine 100 begins to operate at a step S401, the control portion 300 integrates the driving time and the travel distance at a step S402.

The control portion 300 detects the inlet temperature of the oxidation catalyst 200 by using the temperature detector 210 at a step S403, and calculates the desulfurization efficiency according to the inlet temperature of the oxidation catalyst 200 by using the characteristic graph shown in FIG. 7 at a step S404.

After that, the control portion 300 integrates the desulfurization efficiency according to the inlet temperature of the oxidation catalyst 200 to time or distance at a step S405 and calculates the natural desulfurization degree occurring at the normal driving mode at a step S406.

The control portion 300 determines whether the predetermined desulfurization period (e.g., 15,000 km) is reached at a step S407.

If the predetermined desulfurization period (e.g., 15,000 km) is not reached at the step S407, the control portion 300 returns to the step S402.

If the predetermined desulfurization period (e.g., 15,000 km), however, is reached at the step S407, the control portion 300 reflects the integrated desulfurization efficiency on the predetermined desulfurization period (e.g., 15,000 km) and resets the desulfurization period at a step S408.

That is, the control portion 300 adds a value corresponding to the natural desulfurization degree occurring at the normal driving mode to the predetermined desulfurization period and resets the desulfurization period to increase.

If the desulfurization period is reset, the control portion 300 determines whether the reset desulfurization period is reached at a step S409.

If the reset desulfurization period is not reached at the step S409, the control portion 300 determines whether the reset desulfurization period is reached continuously.

After that, if the reset desulfurization period is reached, the control portion 300 raises the temperature of the exhaust gas through the post-injection for the predetermined desulfurization time (e.g., 5 min.). Since the inlet temperature of the oxidation catalyst 200 becomes higher than the desulfurization temperature (e.g., 450° C.), the sulfur poisoned at the oxidation catalyst 200 is removed and the oxidation catalyst 200 is regenerated at a step S410.

After that, if the desulfurization of the oxidation catalyst 200 is performed for the predetermined desulfurization time, the control portion 300 determines that the regeneration of the oxidation catalyst 200 is completed and returns to the initial step.

Therefore, since the desulfurization for regenerating the oxidation catalyst 200 does not occur frequently, fuel economy may be enhanced and noxious exhaust gas emission may be reduced.

Increase of desulfurization according to other embodiments is similar to that according to that described above, and thus detailed description will be omitted.

Since natural desulfurization degree occurring at various driving environments is reflected on desulfurization time or desulfurization period, fuel economy may be enhanced and noxious exhaust gas emission may be reduced according to various embodiments of the present invention.

Desulfurization time is shortened or desulfurization period is extended according to natural desulfurization degree, but reduction of the desulfurization time and increase of the desulfurization period can be simultaneously performed. Therefore, it is to be understood that the scope of the present invention includes that the reduction of the desulfurization time and the increase of the desulfurization period are simultaneously performed.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system for desulfurizing an oxidation catalyst, comprising:
an engine;
an oxidation catalyst purifying harmful substances contained in exhaust gas;
a temperature detector detecting inlet temperature of the oxidation catalyst; and
a control portion integrating a time and/or a distance where natural desulfurization occurs based on the inlet temperature of the oxidation catalyst, and performing desulfurization of the oxidation catalyst by reflecting integrated natural desulfurization occurrence time and/or integrated natural desulfurization occurrence distance on a predetermined desulfurization time and/or a predetermined desulfurization period.

2. The system of claim 1, wherein the control portion calculates integrated time and/or integrated distance where the inlet temperature of the oxidation catalyst is higher than a predetermined desulfurization temperature as the natural desulfurization occurrence time and/or the natural desulfurization occurrence distance.

3. The system of claim 1, wherein the control portion reduces desulfurization time by subtracting a value corresponding to the integrated natural desulfurization occurrence time from the predetermined desulfurization time.

4. The system of claim 1, wherein the control portion increases desulfurization period by adding a value corresponding to the integrated natural desulfurization occurrence time to the predetermined desulfurization period.

5. The system of claim 3, wherein the control portion maintains the predetermined desulfurization period when reducing the desulfurization time.

6. The system of claim 4, wherein the control portion maintains the predetermined desulfurization time when increasing the desulfurization period.

7. The system of claim 1, wherein the control portion reflects the integrated natural desulfurization occurrence time of the oxidation catalyst simultaneously on the desulfurization time and the desulfurization period.

8. A system for desulfurizing an oxidation catalyst, comprising:
an engine;
an oxidation catalyst purifying harmful substances contained in exhaust gas;
a temperature detector detecting inlet temperature of the oxidation catalyst; and
a control portion calculating desulfurization efficiency according to the inlet temperature of the oxidation catalyst, estimating natural desulfurization degree of the oxidation catalyst by integrating the desulfurization efficiency according to the inlet temperature of the oxidation catalyst to time and/or distance, and performing desulfurization of the oxidation catalyst by reflecting the estimated natural desulfurization degree on a predetermined desulfurization time and/or a predetermined desulfurization period.

9. The system of claim 8, wherein the control portion reduces desulfurization time by subtracting a value corresponding to the estimated natural desulfurization degree from the predetermined desulfurization time.

10. The system of claim 8, wherein the control portion increases desulfurization period by adding a value corresponding to the estimated natural desulfurization degree to the predetermined desulfurization period.

11. The system of claim 9, wherein the control portion maintains the predetermined desulfurization period when reducing the desulfurization time.

12. The system of claim 10, wherein the control portion maintains the predetermined desulfurization time when increasing the desulfurization period.

13. The system of claim 8, wherein the control portion reflects the estimated natural desulfurization degree simultaneously on the desulfurization time and the desulfurization period.

14. A method for desulfurizing an oxidation catalyst, comprising:
integrating a time during which an inlet temperature of the oxidation catalyst is higher than a predetermined desulfurization temperature;
resetting, if a predetermined desulfurization period of the oxidation catalyst is reached, desulfurization time by reflecting an integrated time during which the inlet temperature of the oxidation catalyst is higher than a predetermined desulfurization temperature on a predetermined desulfurization time; and
controlling desulfurization of the oxidation catalyst according to the reset desulfurization time.

15. The method of claim 14, wherein the predetermined desulfurization period is maintained when resetting the desulfurization time.

16. A method for desulfurizing an oxidation catalyst, comprising:
integrating a time during which an inlet temperature of the oxidation catalyst is higher than a predetermined desulfurization temperature;
resetting, if a predetermined desulfurization period of the oxidation catalyst is reached, desulfurization period by reflecting an integrated time during which the inlet temperature of the oxidation catalyst is higher than a predetermined desulfurization temperature on a predetermined desulfurization period; and
controlling desulfurization of the oxidation catalyst according to the reset predetermined desulfurization period.

17. The method of claim 16, wherein the predetermined desulfurization time is maintained when resetting the desulfurization period.

18. A method for desulfurizing an oxidation catalyst, comprising:
detecting an inlet temperature of the oxidation catalyst;
calculating desulfurization efficiency according to the inlet temperature of the oxidation catalyst;
estimating natural desulfurization degree by integrating the desulfurization efficiency according to the inlet temperature of the oxidation catalyst to time and/or distance;
resetting, if a predetermined desulfurization period of the oxidation catalyst is reached, desulfurization time by reflecting the estimated natural desulfurization degree on a predetermined desulfurization time; and
controlling desulfurization of the oxidation catalyst according to the reset desulfurization time.

19. A method for desulfurizing an oxidation catalyst, comprising:
detecting an inlet temperature of the oxidation catalyst;
calculating desulfurization efficiency according to the inlet temperature of the oxidation catalyst;
estimating natural desulfurization degree by integrating the desulfurization efficiency according to the inlet temperature of the oxidation catalyst to time and/or distance;
resetting, if a predetermined desulfurization period of the oxidation catalyst is reached, desulfurization period by reflecting the estimated natural desulfurization degree on a predetermined desulfurization period; and
controlling desulfurization of the oxidation catalyst according to the reset desulfurization period.

20. A method for desulfurizing an oxidation catalyst, comprising:
detecting an inlet temperature of the oxidation catalyst;
estimating natural desulfurization according to the inlet temperature of the oxidation catalyst; and
resetting desulfurization time and/or desulfurization period by reflecting the estimated natural desulfurization.

21. The method of claim 20, wherein the natural desulfurization of the oxidation catalyst is estimated by integrating a time during which the inlet temperature of the oxidation catalyst is higher than a predetermined desulfurization temperature.

22. The method of claim 20, wherein the natural desulfurization of the oxidation catalyst is estimated by integrating desulfurization efficiency according to the inlet temperature of the oxidation catalyst to time.

23. The method of claim 20, wherein the predetermined desulfurization period is maintained and the natural desulfurization is reflected on the desulfurization time if the predetermined desulfurization period of the oxidation catalyst is reached.

24. The method of claim 20, wherein the predetermined desulfurization time is maintained and the natural desulfurization is reflected on the desulfurization period if the predetermined desulfurization period of the oxidation catalyst is reached.
